(19) United States
(12) Patent Application Publication
(10) Pub. No.: US 2009/0285668 A1
(43) Pub. Date: Nov. 19, 2009

(54) ROTATING FLEXIBLE WING POWER SYSTEM

(76) Inventor: David R. LABRECQUE, Orono, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 12/267,175

(22) Filed: Nov. 7, 2008

Related U.S. Application Data
(60) Provisional application No. 61/053,569, filed on May 15, 2008.

(51) Int. Cl. F03D 3/00; F03D 9/00

(52) U.S. Cl. 415/8; 290/55

(57) ABSTRACT

A Rotating Flexible Wing Power System for extracting low-cost electricity and mechanical energy from moving fluids including wind and water currents. The Rotating Flexible Wing Power System generally includes a single long curved flexible wing supported at its ends so that it can rotate or swing around a longitudinal axis that intersects the endpoints of the wing. Rotation mechanisms are located at each end of the wing allowing the wing to rotate freely about its longitudinal axis. Lift forces on the wing resulting from the moving fluid cause the wing to start and continue rotating. These lift forces also create oscillating longitudinal forces in the flexible wing which move the ends of the flexible wing towards and away from each other. This movement may be harnessed to drive a generator or pumping device connected to the flexible wing. One or both ends of the wing can be connected to tethers so that the overall length of the flexible wing is increased. A force transfer member can be used to extend the reach of the system so that energy can be extracted from the flexible wing to a generator or pumping device positioned at a convenient distant location.

### CROSS REFERENCE TO RELATED APPLICATION

This application claims priority to a provisional application, U.S. Ser. No. 61/053,569, filed May 15, 2008, entitled Rotating Flexible Wing Power System, by Labrecque, David, which is hereby incorporated by reference.

### BACKGROUND OF THE INVENTION

1. Technical Field

The present invention relates generally to aero-power and hydropower and more specifically it relates to a Rotating Flexible Wing Power system for extracting low-cost electricity and mechanical energy from moving fluids including wind and water currents.

2. Description of Prior Art

Traditional windmills are the most common examples of devices used to capture energy from moving fluids, namely wind. The multiple blades of the windmill rotate about a horizontal axis oriented preferably in parallel with the air flow. The rigid cantilevered blades must be properly angled at each point along their length to optimize rotation. While effective, this design requires an additional mechanism to point it into the wind and it lacks the ability to easily position the blades for maximum angle of attack when the wind shifts. Moreover, traditional windmills are typically massive structures requiring considerable capital costs for construction, operation, and maintenance. Where windmills are combined with generators to produce electricity, the generators are typically located on the support structure, making access to the system and generator difficult. This tower itself must be engineered to handle wind loads and the weight of the wind system and generator. While traditional windmills have been improved upon by the use of rotatable blades for actively changing the blade angle under various wind conditions, such changes have added to the complexity and cost of the design, without addressing the inherent drawbacks of the design.

A device disclosed by Darrieus, U.S. Pat. No. 1,835,018 (Oct. 1, 1926), sought to overcome many of the deficiencies of traditional windmill design by providing for a turbine having fixed rigid blades disposed about a vertically oriented axis. Given that most fluids flow in a substantially horizontal manner, whether air currents or water currents, orienting the axis of rotation of the turbine vertically allowed the Darrieus device to capture energy of moving fluids irrespective of variances of the direction of fluid flow. Thus, a Darrieus turbine mounted on a tower would be as effective whether the wind blew from a constant direction or from shifting directions. The Darrieus device also incorporates a generator located below the wind system at a lower elevation where it can be more easily installed and maintained. However, an inherent flaw with the Darrieus design is the difficulty of building lightweight rigid blades that can handle heavy wind loads. Some prototypes have failed catastrophically in high winds with blade parts flying dangerously outwards at high speeds.

Other devices have employed novel designs to capture energy from fluid flow. For example, Savonius, U.S. Pat. No. 1,766,765 (Oct. 11, 1928), disclosed a rotating vertical axis device with cups that capture wind, causing rotation. Although the device generates high torque, the high stresses in the device require a large structural mass to unit area ratio. This and its utilization of inefficient wind drag forces rather than lift forces make it less efficient and less viable than traditional windmills.

Both Ranger, U.S. Pat. No. 6,523,781 (Feb. 25, 2003), and Webster, U.S. Pat. No. 6,914,345 (Jul. 5, 2005), disclose devices which use one or more tethered airfoils (e.g., kites) to capture wind energy, transferring said energy along the tethers to rotating mechanisms for energy generation. The fundamental feature of these devices is that the airfoil's angle to the wind is continuously increased and decreased resulting in an oscillating movement. This oscillating movement in the lifting body and tethers is converted into useful mechanical motion that can then be used to drive a power generator. These devices have the advantage of being easily oriented to the direction of wind flow for maximum energy capture during energy capture, as well as being able to reach higher elevations where the wind is stronger without the need for expensive load-bearing towers, but they have the disadvantage of requiring complicated systems for controlling and resetting the airfoils and are susceptible to complete operational shutdown when the wind velocity decreases below a minimum level. Energy captures by both devices rely upon airfoils drawing out tethers. Once the tethers have reached maximum extension they need to be retracted, which results in the airfoils being drawn against the air flow with a resulting loss of efficiency. Means are employed to manipulate the orientation of the airfoils relative to the air flow to better allow withdrawal against the air flow, but substantial energy is nevertheless wasted during airfoil retraction. These disadvantages make these designs more difficult and expensive to operate than traditional wind systems.

It is therefore evident that there is a need for a safe, low-cost system for generating power from the flow of fluids. Such system should be simple to erect, operate, and maintain, accommodate fluid flows from any direction, and be efficient in both the power stroke and the return stroke for maximum net energy capture. The present invention discloses such a system.

### SUMMARY OF THE INVENTION

The present invention discloses a low-cost system for safely generating power from the flow of fluids by the use of a single curved flexible wing supported at each of its two ends by corresponding support structures. The wing employs a pair of rotation mechanisms interposed between the ends of the wing and the support structures, with the rotation mechanisms suitably adapted to allow the wing to rotate or swing freely around a central axis. Introduction of a flowing fluid over the wing results in lift forces which rotate the wing in a manner similar to a rigid Darrieus wind turbine. The wing continues through its rotation and is returned to the upwind position by angular momentum. Unlike a Darrieus wind turbine, however, the present invention utilizes a single flexible wing rather than a plurality of rigid wings, and the wing has an optimized mass distribution. The lift forces on the wing change the shape and position of the wing relative to the center of rotation, making the radius of rotation longer on the downwind side (when the wing is bowed out by the force of the wind on the concave inner surface of the wing) and shorter on the upwind side (when the wing is flattened by the force of the wind on the convex outer surface of the wing). The changes to the radius length correspond to a continuous change in the distance between the ends of the wing, with the distance between the ends shorter on the downwind side and longer on the upwind side, resulting in the wing creating longitudinal oscillations of its ends having a relatively large amount of force. The energy from these longitudinal oscillations is captured and may be used to drive a generator or pumping device. A fluid other than air may be used, such as a water current, with the same effect.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of the construction or to the arrangements of the components set forth in the following descriptions, illustrations or drawings. The invention is capable of other embodiments and of being practiced and carried out in various ways. Also, it is to be understood that the phraseology and terminology employed herein are for the purpose of the description and should not be regarded as limiting.

An object is to provide a Rotating Flexible Wing Power System for extracting low-cost electricity and mechanical energy from moving fluids including wind and water currents.

Another object is to provide a Rotating Flexible Wing Power System that is inexpensive to manufacture and operate.

Another object is to provide a Rotating Flexible Wing Power System that is self-starting.

Another object is to provide a Rotating Flexible Wing Power System that can convert wind energy to electrical power.

Another object is to provide a Rotating Flexible Wing Power System that can convert water currents to electrical power.

Another object is to provide a Rotating Flexible Wing Power System that can utilize wind energy to mechanically pump fluids such as water from wells.

Another object is to provide a Rotating Flexible Wing Power System mounted in a vertical or angled configuration that can extract energy from fluids flowing in any direction.

Another object is to provide a Rotating Flexible Wing Power System that mounts between natural or man-made structures so that energy is extracted from the cross sectional areas of flowing air, water, or other fluids between these structures.

Another object is to provide a Rotating Flexible Wing Power System that mounts between movable supports such that the wing can be made to face into the wind to extract an optimum amount of energy.

Another object is to provide a Rotating Flexible Wing Power System that utilizes a long flexible rotating wing to attain relatively high altitudes at the top of its trajectory extracting the larger amount of energy that exists at higher altitudes.

Another object is to provide a Rotating Flexible Wing Power System made of an array of rotating wings suspended either in vertical, angled or horizontal configurations between any combination of the following: flat ground, hills, mountains, and man-made objects like bridges, towers, and buildings.

Another object is to provide a Rotating Flexible Wing Power System that can be mounted on top of tall buildings either in vertical, angled or horizontal configurations.

Another object is to utilize the Rotating Flexible Wing Power System in place of sails on a sailboat to propel it through the water.

Other objects and advantages of the present invention will become obvious to the reader and it is intended that these objects and advantages are within the scope of the present invention. To the accomplishment of the above and related objects, this invention may be embodied in the form illustrated in the accompanying drawings. Attention is called to the fact, however, that the drawings are illustrative only, and that changes may be made in the specific construction illustrated and described within the scope of this application.

### DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1A depicts a side view of the present invention 1 illustrating a vertical configuration with a single rotating flexible wing 10 suspended on a tree by rigid support members 100,102. (An alternate position of the wing 10 is depicted in dotted line.) Wind is blowing from left to right. With the wing 10 in the upwind position the radius r′ is shortened and the longitudinal distance d′ is lengthened.

FIG. 1B depicts the same view as is shown in FIG. 1A after the wing 10 has rotated 180 degrees. (An alternate position of the wing 10 is depicted in dotted line.) With the wing 10 in the downwind position the radius r″ is lengthened relative to radius r′ and the longitudinal distance d″ is shortened relative to distance d′. This length change to d is transmitted through a force transfer member 40 so that these oscillations drive an electric generator 110 located on the ground.

FIG. 2 is a front view of the present invention illustrating a horizontal application of the rotating wing 10 suspended between hills. (An alternate position of the wing 10 is depicted in dotted line.) Tethers 70, 80 are used here to extend the length of the wing 10, connecting the wing ends with the rotation mechanisms 62,64. The large cross sectional area of wind enables this system to extract an enormous amount of energy from even low speed winds. In this case the force transfer member and retraction device are integrated with and interior to the generator 110, which also serves as a support structure 100.

FIG. 3 is a front view of the present invention illustrating how the design can be placed in water where a rotating wing 10 extracts energy from the water current. (An alternate position of the wing 10 is depicted in dotted line.) In this application the wing 10 is suspended by tethers 70,80 to fixed support structures 100,102. A force transfer member 40 transmits the energy in the oscillations from the rotating wing 10 to the generator 110.

FIGS. 4A, 4B, and 4C illustrate how a Darrieus wind system works. FIG. 4A is a schematic top view of a rotating wing with a fixed radius r illustrating the “effective wind” experienced by a wing at four different positions as it rotates without a wind.

FIG. 4B illustrates how the effective wind vectors in FIG. 4A change in angle and magnitude when there is a wind (the vectors at a and c change in magnitude while the vectors at b and d change in angle and magnitude).

FIG. 4C shows the resulting lift forces the wing experiences at the four positions (the lift forces are represented by the heavier arrows l′ and l″). Since the radius r is fixed in a Darrieus system, the net effect of these forces results in a torque that continues the counterclockwise rotation. Note that drag forces are ignored since the rotation speed is high enough that the wind vector angle to the wing is less than 15 degrees.

FIG. 4D is a schematic top view of the present invention where the radius of rotation r can change. The same forces shown in FIG. 4C not only rotate the wing, they also result in changes to the radius r which can be used to extract energy from the wind.

FIG. 5 is a side view of the long flat flexible wing 10 showing the radial lift force L corresponding to l′ and l″ shown in FIG. 4D. Also shown is an inward radial force f resulting from the wing being constrained at its endpoints and an effective outward “centrifugal force” F_{c} resulting from the wing's mass and its rotation.

FIG. 6 depicts a stabilizing mass 20 in the flexible wing 10, which along with a strut 50 in the center keeps the wing 10 taut in the wind as it rotates. This stabilizing mass 20 also stores energy when the wing 10 is on the upwind side that is later extracted by the system. The stabilizing mass 20 also maintains the wing's 10 angular momentum. FIG. 6 depicts an optimal position for the wing's 10 longitudinal axis 18 and stabilizing mass 20, i.e., 25% of the distance between the leading edge 16 and the trailing edge 17 of the wing 10.

FIG. 7 is a schematic top view of the present invention depicting where the radial forces should act on the wing in a preferred embodiment. Lift force L, corresponding to the radial component of l′ and l″, acts 25% from the leading edge 16 of a typical wing 10. The effective centrifugal “force” F_{c} of the stabilizing mass 20 and the constraining force f resulting from the tension forces in the wing 10 should all act at one point. Otherwise the wing 10 will experience a torque which will turn it out of the wind.

FIG. 8 is a graph that shows lift and drag forces as a function of the angle of a wing with respect to the wind. Note that for small angles less than 15 degrees, drag forces can be ignored and the lift forces dominate. This is the case for a wing rotating or swinging about a central axis at an appreciable speed. The experimental data shown is from Sandia National Labs report SAND80-2114, entitled “Aerodynamic Characteristics of Seven Symmetrical Airfoil Sections Through 180-Degree Angle of Attack For Use In Aerodynamic Analysis of Vertical Axis Wind Turbines”, by R. E. Sheldahl and P. C. Klimas.

FIG. 9 is a top view of the present invention, depicting the rotating wing 10 in a horizontal configuration, which can be tracked to face into the wind. (An alternate position of the wing 10 is depicted in dotted line.) Large carts 140 that act as support structures 100,102 run on railroad tracks 130, orienting the wing 10 so that the largest cross-sectional area of the wing 10 will face the wind. The carts 140 may also hold the generator and control mechanisms.

FIG. 10A is a side view depicting an angled configuration of the present invention where Rotating Flexible Wings 10 are used in place of sails on a sailboat 150; FIG. 10B is a rear view of FIG. 10A. (Alternate positions of the wings 10 are depicted in dotted line.) Energy from these wings 10 can be used to drive a generator or pump which ultimately propel the boat 150 with an electric motor or water pumped through a nozzle at the back of the boat 150 for jet propulsion.

### DETAILED DESCRIPTION OF THE INVENTION

### Overview

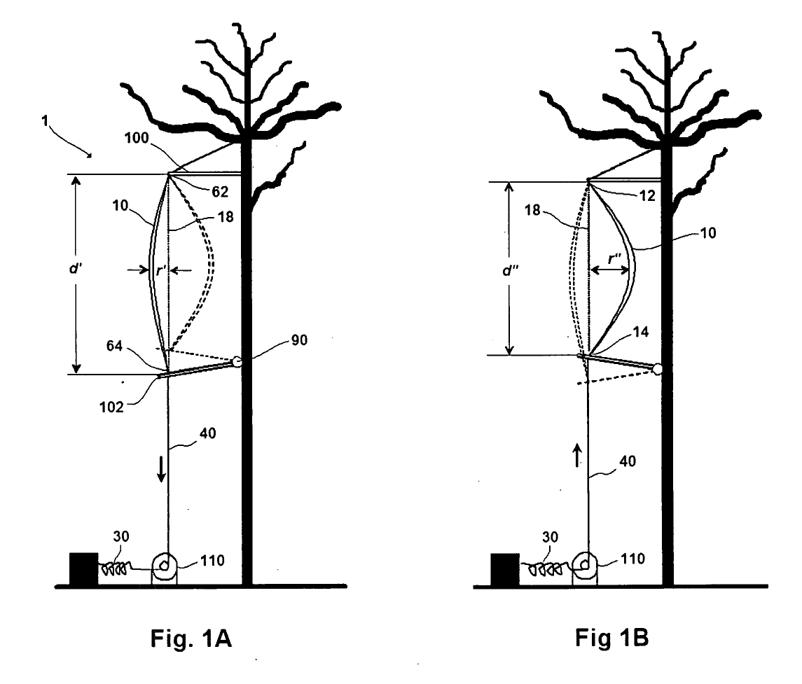

Turning now descriptively to the drawings, in which similar reference characters denote similar elements throughout the several views, the figures illustrate a single long flexible wing 10 supported at its ends 12,14 so that it can rotate or swing around a central axis 18. See FIGS. 1A and 1B. Rotation mechanisms 62,64 are located at each end 12,14 of the wing 10 allowing the wing 10 to rotate freely. One or both ends 12,14 of the wing 10 may be connected to tethers 70,80 interposed between the main portion of the wing 10 and the rotation mechanisms 62,64. Energy is extracted from the longitudinal oscillations as the wing 10 rotates in a flowing fluid like air, either directly or through a force transfer member 40 to a generator 110 or pumping device positioned at a convenient location. The device is thus seen to efficiently convert rotational energy to linear energy.

### Long Flexible Wing

The long flexible wing 10 is designed to withstand large tensile, oscillating, longitudinal forces that result as the wing 10 rotates in a flowing fluid. These forces are transmitted either directly or through the force transfer member 40 to an electrical generator 110 or pumping device. See FIGS. 1, 2, and 3. The rotating flexible wing 10 does not twist significantly in the wind and lose energy because of some or all of the following features: the wing 10 is supported at its ends 12,14 by support structures 100,102; the wing's 10 shape is optimized; the wing 10 extracts longitudinal forces rather than rotational torques; the wing's 10 stabilizing mass 20 exerts an outward centrifugal “force”; and a retraction device 30 takes up the slack in the wing 10 when the wing 10 is lengthened (when it is rotated to the upwind side). The following features and their positions are variations of the basic invention.

The long flexible wing 10 can be composed of high tensile strength, low elasticity fibers that run longitudinally from one end of the wing 10 to the other. These handle the large forces that occur in the wing 10 while it is rotating about the central axis 18. The fibers can be bound in position by a material that will withstand various environmental conditions depending on the application. The fibers can be bonded or attached to the end points 12,14 of the wing 10 in such a way that the tethers 70,80 or rotation mechanisms 62,64 can be connected to these points. In other embodiments the elasticity of the fibers may be increased or decreased, as appropriate, provided the wing 10 retains its flexibility. In other embodiments the wing 10 may be composed of other materials and structures, not involving fibers, provided the wing 10 retains its strength and flexibility.

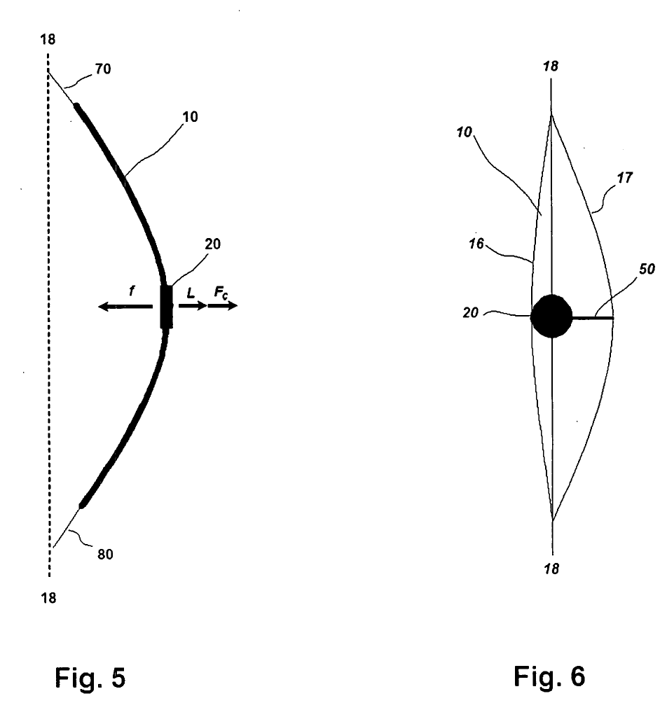

The entire wing 10 is flexible so that it can form a curved shape that changes shape as it rotates around a central axis 18 in a flowing fluid. See FIGS. 1A and 1B. The center of the wing 10 can have a stabilizing mass 20 or a strut 50 or both that keeps the wing's 10 shape taut in the flowing fluid. See FIGS. 5 and 6. The strut 50 behaves like a stay in a sail keeping the wing 10 straight along the transverse axis of the sail. The stabilizing mass 20 holds the wing 10 taut as it rotates due to the resulting centrifugal “forces” that occur as the wing 10 rotates. The stabilizing mass 20 also helps the wing 10 maintain a higher angular momentum that keeps the wing 10 rotating should the flowing fluid slow or stop temporarily. The design and flexible nature of the wing 10 also contribute to the ability of the wing 10 rotation to self-start. This is a feature that a Darrieus type system lacks. The wing's 10 shape and the exact position and shape of the stabilizing mass 20, strut 50, and endpoints 12,14 are typically optimized to maximize the energy that can be taken from the flowing fluid. The wing's 10 profile is not limited to the flat shape shown in the drawings but can be an optimized airfoil or hydrofoil shape depending on application. Other criteria such as self-starting also affect the optimum position of the stabilizing mass 20, shape of the stabilizing mass 20, shape of the wing 10, wing profile, and wing material. For example, a more elastic wing material may be less efficient but have better self-starting characteristics.

A design for maximum energy extraction as shown in FIG. 6, having wing fibers made of Kevlar, carbon, or any material that is strong in tensile stress yet flexible. However, the shape and size of the wing 10, wing profile, and wing material or materials depends on the application.

### Rotation Mechanisms

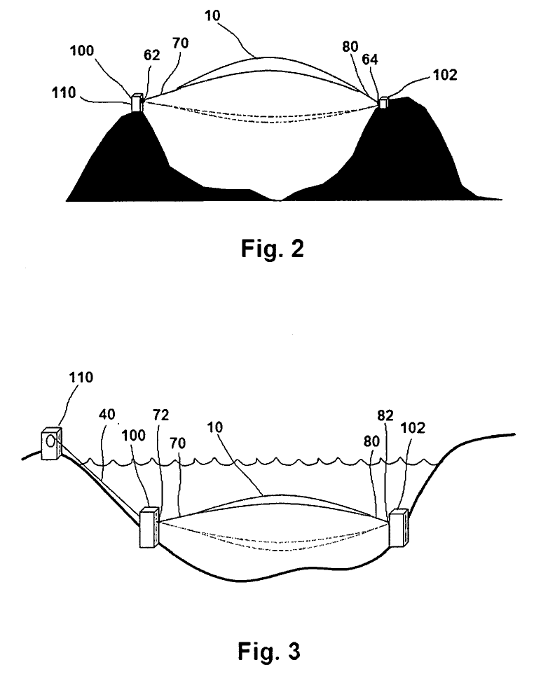

Rotation mechanisms 62,64 are defined here as any mechanical structure that allow the wing 10 to rotate freely with respect to its support structures 100,102, including but not limited to bearings, in a magnetic, electromagnetic, pressured, dry or lubricated medium; swivels with and without ball or other shaped bearings; or any other structure which permits the rotation of an object about an axis. The rotation mechanisms 62,64 allow the wing 10 to rotate about the center axis 18 of the wing 10 while transmitting the longitudinal forces through a force transfer member 40 to an electrical generator 110 or pumping device. The position of the rotation mechanisms 62,64 at the endpoints 12,14 of the wing 10, or at the distal ends 72,82 of tethers 70,80 if such are used, depends on the application. See FIGS. 1 and 2.

### Retraction Device

The retraction device 30 is defined as any energy storage device that will allow the wing distance (radius) to the central rotation axis 18 to oscillate back and forth in the flowing fluid without a significant loss of energy. The retraction device 30 may be a spring, a metal plate having memory, a weight, a magnetic restoring force from a coil or permanent magnet, or any other structure or mechanism having the characteristic of being capable of changing its relative position upon the application of a force and returning to its prior position upon the removal of the force. The retraction device 30 assists in lengthening the wing 10 at the upwind position. In one embodiment a coiled spring is employed, attached to an end of the force transfer member 40. When the wing 10 rotates to the downwind position and its longitudinal length is shortened, the spring is extended, storing some of the longitudinal energy. When the wing 10 rotates to the upwind position, the force on the spring diminishes and the spring retracts, increasing the longitudinal length of the wing 10. See FIGS. 1A and 1B. The retraction device 30 may be integrated with a generator 110 or pumping device.

### Force Transfer Member

A force transfer member 40 is suitably adapted to transmit the longitudinal forces generated by the rotation and radial oscillation of the wing 10. It may be made of high tensile strength, low-elasticity material. Alternatively, it may be made of a more rigid material. The retraction device 30 may be integrated with the force transfer member 40. In applications where the rotating wing 10 is located remotely from the generator 110 or pumping device the force transfer member 40 is used. See FIGS. 1A, 1B, and 3. The purpose of the force transfer member 40 in the vertically configured wind system 1 (see FIGS. 1A and 1B) is to transmit the forces from a wing 10 that is rotating at a high elevation to a ground-based generator 110. In this case the higher end of the wing 10 is attached through a rotation mechanism 62 to a fixed point at the high end of an object, such as a tower or a tree, by means of a support structure 100. A guide mechanism 90 that moves longitudinally with respect to a support structure 102 but limits movements in other directions can be used to control the shape of the wing 10 to optimize power output, enhance self-starting characteristics, or both.

### Connections of Main Elements and Sub-Elements of Invention

The long flexible wing 10 is attached to the rotation mechanisms 62,64 either directly or through tethers 70,80 depending on the application. See FIGS. 1, 2, and 3. The rotation mechanism 62 or tether 70 on one end 12 of the wing 10 is then attached to a fixed point and the rotation mechanism 64 or tether 80 at the other end 14 of the wing 10 is connected directly or via the force transfer member 40 to a generator 110 or pumping device. A guide mechanism 90 may be used to constrain the lateral motion of the end 14 of the wing 10 or tether 80 so as to maximize power output. See FIGS. 1A and 1B. Alternatively, the rotation mechanism 62 or tether 70 at the end 12 of the wing 10 opposite the generator 110 or pumping device may be attached to a movable support structure 100.

### ALTERNATIVE EMBODIMENTS OF INVENTION

The rotating single wing 10 can be used in various configurations. Like a Darreius wind turbine, a vertical configuration of the rotating single wing 10 will rotate and generate forces to drive a generator 110 or pumping device from wind from any direction. Unlike the Darreius turbine, the flexible wing system 1 has the ability to self-start. Since power can be transmitted through the force transfer member 40 to a ground-based generator 110 or pumping device, the wing 10 can be located on a high tower where winds are stronger without need to also maintain the generator 110 at a high elevation.

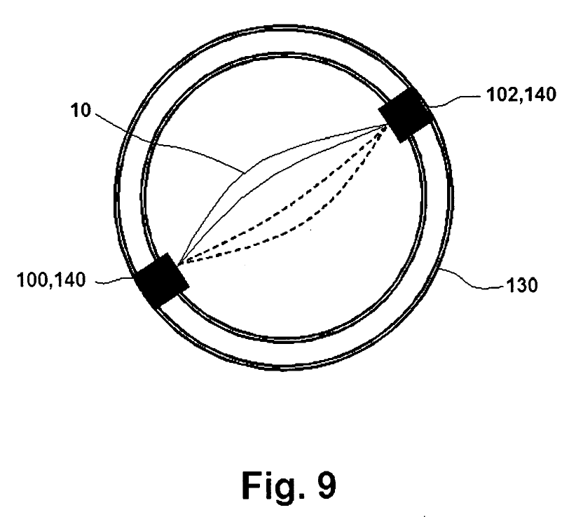

A fixed horizontal configuration can be utilized in air if the wind direction is constant. A fixed horizontal configuration will generate energy within 15 degrees of the prevailing wind direction. A variation of the horizontal configuration utilizes a circular tracking system 130 to make the horizontal rotating wing 10 face into the wind regardless of shifting directions. See FIG. 9.

By controlling when energy is extracted from the wing 10, or changing the shape of the wing 10, stabilizing mass 20 shape, stabilizing mass 20 position, and/or tether positions on the wing 10, or actively controlling the wing angle, the horizontal wing 10 can be made to climb higher and reach the more energy laden winds that exist at higher altitudes. See FIG. 2. This variation could have an electronically controlled generator 110 or pumping device at both ends 12,14 with the purpose of better controlling the wing path and thus extracting more energy.

The invention can also be used in water currents in a stream, river, or tidal flow, where the generator 110 or pumping device is on shore or on a fixed platform. See FIG. 3. The wing cross-sectional profile can be flat as shown in the drawings here or be optimized to be a wide variety of aerodynamic and hydrodynamic profiles like an airplane wing or dolphin fin.

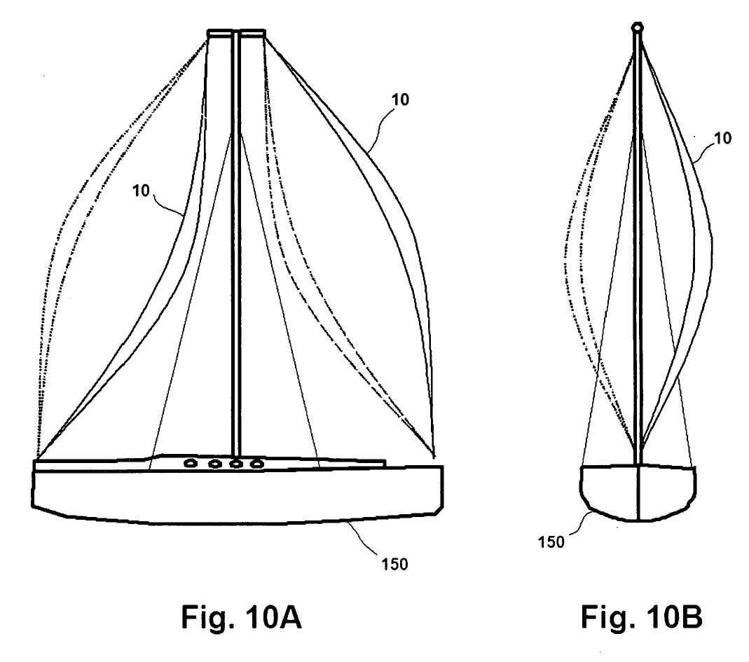

An angled configuration of the invention can be used on a boat 150 where the flexing wings 10 are mounted on a mast. See FIG. 10. The flexing wing 10 can drive a generator 110 or a pump. The generator 110 can be used to charge a battery that is then used to drive an electric motor with a propeller. Alternatively, the pump can pump water through a nozzle at the rear of the boat 150 propelling the boat 150 forward via jet propulsion.

### Operation of Preferred Embodiment

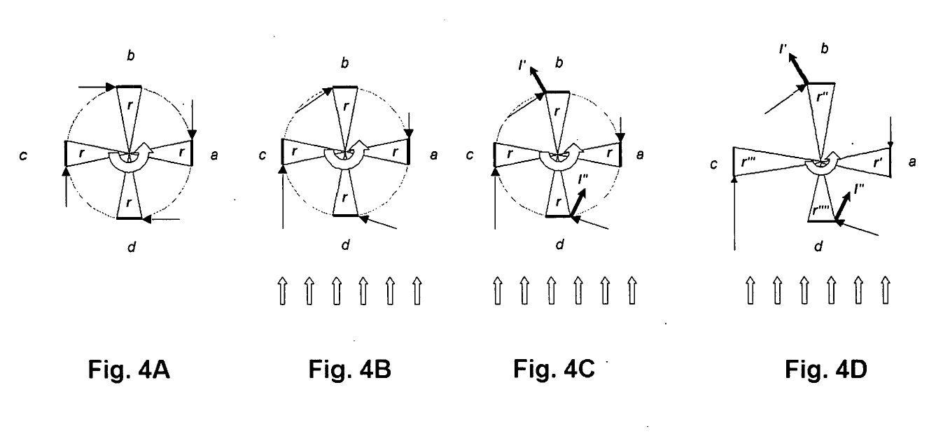

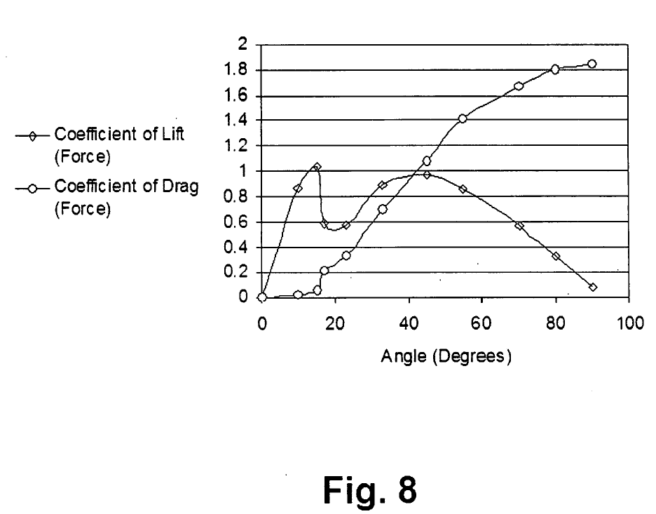

A curved long flexible wing 10 supported at its ends 12,14 by rotation mechanisms 62,64 will rotate or swing around a central axis 18 that intersects those endpoints 12,14 in a flowing fluid due to forces similar to those of a Darrieus wind system. A wing rotating in still air without a headwind will experience an effective wind due to the rotation as shown in FIG. 4A. The wing experiences minimal drag forces because the effective wind is parallel or head-on to the wing at every point in the circular track. See FIG. 8. In other words, the effective angle of attack is 0 degrees at every point. Adding a head wind from a fixed direction will change the effective angle of attack. See FIG. 4B. The direction of the effective wind, when adding significant rotation plus headwind vectors, is typically less than 15 degrees. See FIG. 4C. At this low angle of attack the wing still experiences minimal drag forces. See FIG. 8. Lift forces result which causes the wing to rotate faster. These lift forces also make the radius of the rotation r longer on the downwind side of the rotation path and shorter on the upwind side of the path. See FIG. 4D. For rigid type systems like a Darrieus wind system, these radial forces are not relevant as they are not used to generate power, and moreover they are problematic because they can bend or break the rigid wings. The rotating flexible wing system 1 of the present invention, on the other hand, utilizes these forces by transmitting them to the ends 12,14 of the wing 10 where they can be used to drive a generator 110 or a pumping device. These forces can be transmitted through a force transfer member 40 to a generator 110 or pumping device so that these devices can be located at a distance from the rotating wing 10. A guide mechanism 90 might be used to control the shape of the wing 10 and to constrain the end 12 of wing 10 to move only in a longitudinal direction. See FIG. 1. The force transfer member 40 allows the wing 10 to be located at a higher elevation while the generator 110 or pumping device is on the ground or on some other convenient location where it can be easily maintained.

The changes in the wing length along the central axis 18 drives the generator 110 or pumping device. Since power can only be extracted while the wing 10 is pulling, a retraction device 30 is used to retract the force transfer member 40 and keep the wing 10 taut while it resets for the next power cycle. In the case of a generator 110, a linear motion to rotating motion mechanism like the ratcheting sprocket on a bicycle wheel can be used. A specialized linear type of generator 110 can also be used. A pumping device that uses a one way valve moving up and down in a well can be used to pump water out of a well. These devices are widely available and numerous designs exist and have been described in the literature, so they will not be described here.

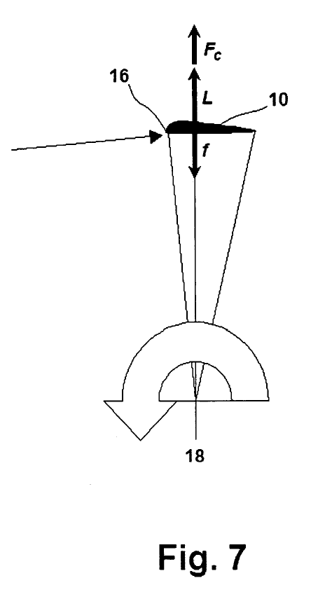

The shape of the long flexible wing 10 and the location of the stabilizing mass 20 and endpoints 12,14 are important factors in maximizing the efficiency of the system 1. Lift forces act at 25% from the leading edge 16 of the wing 10. See FIG. 7. This should be the location of the center of gravity of the stabilizing mass 20. A line passing through the endpoints 12,14 of the wing 10 should also go through this lift force line that is 25% from the leading edge 16, otherwise the wing 10 experiences a torque that turns it out of the wind. See FIG. 6.

The invention extracts energy from the wind on both the upwind side (see FIG. 1A) and the downwind side (see FIG. 1 B) of its rotation. FIG. 4D illustrates the resultant lift forces on the upwind side and downwind side. Note changes in the radius of rotation r introduce a small radial velocity that affects the effective wind angle. These changes in the wind angle are ignored in the following description by assuming the radius changes are small compared to the wing's 10 rotational velocity. Starting at position a and continuing through position c in FIG. 4D, the wing 10 experiences an outward force that increases the radius r and shortens the longitudinal axis 18 distance d. This is the power stroke that drives the generator 110 or pump. After position c the wing 10 experiences a wind lift force that reduces the radius r. This is separate from the force due to the retraction device 30. The rotating wing's 10 stabilizing mass 20 resists being driven towards the center of rotation. Wind energy is thus extracted, driving the wing's 10 stabilizing mass 20 toward the center. Angular momentum is conserved resulting in increased rotational speed. In effect, wind energy is stored as rotational energy. This is similar to an ice skater going into a spin. The skater exerts energy by pulling in his or her arms, making the skater spin faster and increasing the skater's rotational energy. When the inward lift force diminishes, the wing's 10 stabilizing mass 20 contributes to an increasing net outward force on or before position a. This energy gathered on the upwind side is then extracted as part of the power stroke and the cycle repeats.

Since the angle of attack of the wing 10 into the effective wind vector is less than a few degrees when rotating, drag forces are negligible and lift forces dominate. The maximum efficiency in Darrieus turbines and propeller systems where lift forces are dominant is approximately 40%. This approaches the theoretical maximum Betz limit of 59%. The rotating flexible wing 10 efficiency should also approach 40% efficiency since there are no dissipative elements in the design and energy is stored in the spring or in the rotational energy of the wing 10 until it can be extracted later in the cycle.

As with all similar systems the overall efficiency is dependent on many factors. Energy is stored in the spring and the rotating flexible wing's 10 kinetic energy during its rotation. Computer simulations show how the rotational kinetic energy and the spring potential energy cycle as the wing 10 rotates in the wind. With minimal energy lost due to drag forces, excess energy is stored in the spring and the angular velocity of the stabilizing mass 20 until it is extracted from the system 1 as the wing 10 pulls on a generator 110 or pumping device. The efficiency of the flexible rotating wing system 1 and the ease of manufacturing, operating, and maintaining both small and large systems allow it to extract energy and produce power at low cost.

The flexible wing 10 is capable of self starting because the wing 10 can be in only three states, two of which are unstable and a third stable state that is the desired rotating state. The first unstable state is where the wing 10 is in a fixed motionless position downwind where lift, drag, and constraining forces are in balance. The slightest variations in wind make this state unstable. The second unstable state is where the wing 10 rotates backwards with the trailing edge 17 acting as the leading edge 16. This state is also unstable since the lift, centrifugal “force”, and constraining force do not act on one point on the wing 10 cross-sectional surface. The resultant forces exert a torque on the wing 10 causing the wing 10 to turn, resulting in the wing 10 having an erratic, unstable, oscillating, and sometimes backward rotating trajectory. An optimum designed wing 10 self starts after randomly going through the various states, eventually finding the optimum rotating state that is stable. It remains in this state and produces the optimum flexing forces for driving a generator 110 or pump.

What has been described and illustrated herein is a preferred embodiment of the invention along with some it its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

I claim:

1. A rotating flexible wing power system, comprising
a single elongated flexible wing having a fluid flow foil cross section, said flexible wing having first and second ends, a first side comprising a leading edge, a second side comprising a trailing edge, and a longitudinal axis,
the first and second ends of the flexible wing being oriented along the longitudinal axis, and
the first and second ends of the flexible wing being rotatably mounted to first and second support structures, said first and second ends being free to move along the longitudinal axis of said flexible wing towards and away from each other in response to flexing and unflexing of said flexible wing;
a stabilizing mass, said stabilizing mass located on a surface of the flexible wing between the first and second ends of the flexible wing; and
a retraction device, said retraction device suitably adapted to apply a force to the flexible wing to elongate the flexible wing, thereby moving the ends of the flexible wing away from each other;
whereby the flexible wing is suitably adapted to rotate as a result of fluid flow across said flexible wing, with rotation of the flexible wing causing flexing of said flexible wing, said flexing causing movement of the first and second ends along the longitudinal axis resulting in energy being generated by the rotating flexible wing power system.

2. The power system of claim 1 wherein the retraction device comprises a spring.

3. The power system of claim 1 further comprising a force transfer member, said force transfer member connected to the flexible wing and used to transfer energy generated by movement of the first and second ends along the longitudinal axis away from the flexible wing.

4. The power system of claim 3 further comprising an electric generator, said generator being in connection with the force transfer member such that movement of the force transfer member causes said generator to produce electricity.

5. The power system of claim 1 further comprising an electric generator, said generator being in connection with the flexible wing such that movement of the ends of the flexible wing causes said generator to produce electricity.

6. The power system of claim 3 further comprising a mechanical pump, said pump being in connection with the force transfer member such that movement of the force transfer member causes said pump to move fluids.

7. The power system of claim 1 further comprising a mechanical pump, said pump being in connection with the flexible wing such that movement of the ends of the flexible wing causes said pump to move fluids.

8. The power system of claim 1 further comprising a first rotation mechanism, said first rotation mechanism suitably adapted to rotatably mount the first end of the flexible wing to the first support structure.

9. The power system of claim 8 wherein the flexible wing further comprises a first tether, said first tether having a proximate end and a distal end, whereby the first end of the flexible wing is the distal end of the first tether.

10. The power system of claim 8 further comprising a second rotation mechanism, said second rotation mechanism suitably adapted to rotatably mount the second end of the flexible wing to the second support structure.

11. The power system of claim 10 further comprising a second tether, said second tether having a proximate end and a distal end, whereby the second end of the flexible wing is the distal end of the second tether.

12. The power system of claim 1 wherein the stabilizing mass is located proximate to a central portion of the flexible wing, with a center of gravity of the stabilizing mass offset towards the leading edge of the flexible wing and away from the trailing edge of the flexible wing.

13. The power system of claim 12 wherein the center of gravity of the stabilizing mass is located approximately 25% of the distance between the leading and trailing edges of the flexible wing.

14. The power system of claim 1 wherein the flexible wing further comprises a strut, said strut located on a surface of said flexible wing between the first and second ends of the flexible wing.

15. The power system of claim 14 wherein the strut is located proximate to a central portion of the flexible wing and oriented substantially parallel to a transverse axis of the flexible wing.

16. The power system of claim 1 further comprising a guide mechanism, said guide mechanism being suitably adapted to constrain lateral movement of an end of the flexible wing.

17. A method for generating energy, which comprises the steps of:
A. providing a single elongated flexible wing having a fluid flow foil cross section, said flexible wing having first and second ends and a longitudinal axis, the first and second ends being oriented along the longitudinal axis and being rotatably mounted to first and second support structures, said first and second ends being free to move towards and away from each other along the longitudinal axis, said flexible wing further having a stabilizing mass, said stabilizing mass located on a surface of the flexible wing between the first and second ends of the flexible wing, and said flexible wing further having a retraction device, said retraction device suitably adapted to apply a force to the flexible wing to elongate the flexible wing, thereby moving the ends of the flexible wing away from each other;
B. flowing a fluid across the flexible wing to cause the flexible wing to rotate, said rotation causing flexing of said flexible wing, resulting in the first and second ends moving alternately towards and away from each other along the longitudinal axis; and
C. using force generated by the movement of the first and second ends along the longitudinal axis as the flexible wing flexes during rotation to generate energy.

18. The method of claim 17 wherein the flexible wing is oriented substantially vertically.

19. The method of claim 17 wherein the flexible wing is oriented substantially horizontally.

20. The method of claim 17 wherein the longitudinal axis of the flexible wing is oriented at an angle to the vertical.

21. The method of claim 17 wherein the fluid flowing across the flexible wing is air and the flexible wing is placed in an air current, with the flexible wing oriented substantially horizontally, step A of said method further comprising positioning the flexible wing at a relatively high altitude to capture greater wind energy.

22. The method of claim 17 wherein the fluid flowing across the flexible wing is water and the flexible wing is placed in a water current.

23. The method of claim 17 further comprising the following step:
D. producing electricity from the energy generated by step C of said method through use of a generator, said generator being in connection with said flexible wing.

24. The method of claim 17 further comprising the following step:
D. moving fluid by applying the energy generated by step C of said method to a pump, said pump being in connection with said flexible wing.

25. The method of claim 17 wherein a multiplicity of the single elongated flexible wing of step A is provided, the fluid of step B is flowed across each of the multiplicity of flexible wings causing each said flexible wing to rotate and flex, and the energy generated in step C results from the movement of the respective first and second ends along the corresponding longitudinal axis of each of the multiplicity of flexible wings.
